(19) United States
(12) Patent Application Publication
(10) Pub. No.: US 2026/0009712 A1
(43) Pub. Date: Jan. 8, 2026

(54) METHOD FOR ASCERTAINING THE VISCOSITY OF A SAMPLE USING A ROTARY VISCOSIMETER

(71) Applicant: ANTON PAAR GMBH, Graz-Strassgang (AT)

(72) Inventors: Philipp HUBER, Graz (AT); Roland DOHR, Graz (AT); Simon BAUER-KIESLINGER, Graz (AT); Ulf PANITZKI, Graz (AT); Wolfgang WETL, Hitzendotf (AT); Peter KRAXNER, Fernitz (AT); Wolfgang SCHÜTZ, Graz (AT)

(21) Appl. No.: 18/993,685

(22) PCT Filed: Jul. 7, 2023
(86) PCT No.: PCT/AT2023/060226

§ 371 Date: Jan. 13, 2025

(30) Foreign Application Priority Data
Jul. 13, 2022 (AT) A50516/2022

(51) Int. Cl. G01N 11/14

(52) U.S. Cl. CPC G01N 11/14

(57) ABSTRACT

A method ascertains the viscosity of a sample using a rotary viscosimeter. A measuring body is arranged on a measuring shaft, and a second measuring part is arranged on the rotary viscosimeter. The distance between the measuring body and the second measuring part is reduced until a flow can pass between the measuring body and the second measuring part, thus defining a zero distance between the measuring body and the second measuring part. The distance between the measuring body and the second measuring part is increased from the zero distance such that a defined measuring gap is set. The second measuring part is removed, a sample is introduced into the second measuring part, and the second measuring part is repositioned. A viscosity measurement is carried out on the sample, and the viscosity of the sample is determined by an analysis unit.

The present invention relates to a method for ascertaining the viscosity of a sample by means of a rotary viscosimeter in accordance with the preamble of patent claim 1 and to a rotary viscosimeter for measuring the viscosity of a sample in accordance with the preamble of patent claim 13.

From the prior art, a large number of rotary viscosimeters and methods for determining the viscosity of samples are known, with which two measuring parts, a “spindle” and, for example, a measuring cup, into which a sample is introduced, are known. With the rotary viscosimeters of simple construction known from the prior art, however, there is the disadvantage that the setting of the measuring gap is performed by hand and is therefore very complicated and prone to error. Particularly in the case of measurements that take place under special thermal conditions, manual setting of the measuring gap leads to viscosity errors.

It is therefore an object of the present invention to provide a method by means of which measurement of the viscosity of a sample can be carried out easily and susceptibility to error can be reduced.

This object is achieved in the case of a method according to the invention, as per the preamble, by means of the characterizing features of claim 1. According to the invention, it is envisaged here that, in order to adjust the clearance between the measuring body and the second measuring part, an adjusting drive is provided, wherein the measuring gap is specified by a control unit using the adjusting drive.

Adjusting the clearance between the measuring body and the second measuring part by means of the adjusting drive allows simple and repeatable setting of the measuring gap and of the clearances, and this reduces susceptibility to error by untrained users, particularly in the case of simple rotary viscosimeters.

In methods according to the invention, the measuring body is designed as a spindle, conical measuring body or plate, for example. In methods according to the invention, the second measuring part can be designed as a measuring cup or plate, for example. In this case, the sample is in each case positioned between the measuring body and the second measuring part and its viscosity determined. Typical samples that are measured by a method and a rotary viscosimeter according to the invention are, for example: adhesives, dyes, oils, salad oils, polymers.

Particularly advantageous embodiments of the method according to the invention are defined more specifically by the features of the dependent claims:

In the construction of simple rotary viscosimeters, production-related dimensional tolerances of the measuring body or spindle and also of the second measuring part lead to the measuring gap exhibiting deviations from the set measuring gap depending on the measuring body or second measuring part, and these dimensional deviations negatively affect or distort the value of the viscosity determined. In order to reduce the dimensional tolerance and other negative influences on the measurement, it is envisaged that the evaluation unit is supplied, in particular via a wireless or wired connection, preferably from a memory, with a correction table in which correction values for the respective pairing of the measuring body and the second measuring part are recorded and wherein, during the determination of viscosity by the evaluation unit, the correction table is taken into account and, in this way, a corrected value of the viscosity is determined.

The recording of the correction table is used to compensate for dimensional tolerances inherent in manufacture and to take them into account in evaluating the viscosity. In this case, the correction values can be carried out on the same rotary viscosimeter with the installed measuring body and the second measuring part or, for example, can be generated, using reference liquids in each case, just after production of the parts at the manufacturer's own premises. It is advantageously envisaged here that the correction table and/or the correction values for different temperatures and/or speeds, which each correspond to the speeds and temperatures of the test conditions, are/is supplied to the evaluation unit.

A preferred method of generating the correction table can be provided by generating the correction table by means of analyses carried out on the rotary viscosimeter or a reference viscosimeter or
by generating the correction table by means of analyses after the production of the measuring body and/or the second measuring part and making it available to the rotary viscosimeter,
wherein respective samples of known viscosity are used for the generation of the correction table and/or of the correction values.

Operation by the user is further simplified if the rotary viscosimeter has a detection module, which automatically detects the respective second measuring part installed and/or the respective measuring body installed, wherein the evaluation unit selects the respective correction value for the viscosity value from the correction table with reference to the respective detected measuring body and second measuring part,
wherein the correction table or the correction value, in particular, is stored in the respective measuring body and/or the respective second measuring part, and the correction table or the correction value is transferred to the evaluation unit by the detection module when the respective measuring body and/or the respective second measuring part is installed on the rotary viscosimeter. It is thus possible, for example, by means of the detection module, for the respectively installed second measuring part or the respectively installed measuring body to be detected and for the stored correction values or correction tables to be automatically selected by the evaluation unit. As a result, the user has only to install the respective parts of the rotary viscosimeter, and the respective correction tables or correction values are selected automatically. This furthermore also reduces the susceptibility to error in determining the viscosity of samples.

Since, during the determination of the viscosity, the sample is generally subject to a defined temperature profile or the measurement is carried out at defined high temperatures, provision can advantageously be made, in order to remove the measuring body, for the measuring body to be automatically or selectively ejected by means of a spindle extraction mechanism on completion of measurement. By virtue of the spindle extraction mechanism, the user does not need to touch the spindle or measuring body itself and, if it is hot, can easily remove it from the viscosimeter and, if there are further measurements, for example, install a new measuring body. This avoids burns—due to the hot measuring body—or incorrect removal or installation of the measuring body, for example.

To enable the temperature at which measurement is carried out to be set easily and in an energy-efficient manner, provision can be made for the rotary viscosimeter and/or the second measuring part to have a temperature control element, in particular a Peltier element, by means of which the temperature of the sample can be set, in particular increased or reduced, before the start of measurement, and wherein the second measuring part and/or the rotary viscosimeter have/has an insulating element, by means of which the second measuring part is at least partially thermally insulated from the surroundings.

Particularly in the case of measurements in which the sample is subjected to a certain temperature profile or a certain temperature, provision can advantageously be made for correction values for the thermal expansion of the measuring body and/or of the second measuring part to be additionally recorded in the correction table, wherein the thermal expansion of the measuring body and/or of the second measuring part are/is taken into account in setting the measuring gap and/or in evaluating the viscosity.

To enable a number of measurements to be carried out easily one after the other, provision can be made, on completion of measurement, for the measuring body and/or the second measuring part to be exchanged, and for determination of the viscosity of a new or of the same sample to be carried out with the same rotary viscosimeter and a different measuring body and/or second measuring part.

To enable the correction table to be supplied easily to the evaluation unit, provision can be made for the measuring body and/or the second measuring part to have a detection feature, in particular a barcode, NFC chip or a memory, which, when the respective measuring body and/or the second measuring part are/is inserted, is detected or read out by the rotary viscosimeter and/or the evaluation unit, and wherein the respective correction value and/or the respective correction table are/is supplied to the evaluation unit for the evaluation of the viscosity and/or is selected by the evaluation unit.

An alternative embodiment of the method according to the invention is provided in that, after step c), the setting of the measuring gap is stored and the clearance between the measuring body and the second measuring part is increased and, in the fourth step, the second measuring part is removed and a sample is introduced into the second measuring part, the second measuring part is repositioned and the clearance between the measuring body and the second measuring part is reduced, wherein the measuring body is dipped into the second measuring part with the sample located therein, and the previously stored measuring gap is set again.

To enable individual functional parts to be varied for different measurements, provision can be made for the rotary viscosimeter to consist of at least two functional units, wherein the first functional unit comprises the drive, the measuring shaft, the measuring unit and the stand of the rotary viscosimeter, and wherein the second functional unit comprises the second measuring part, the adjusting drive and the gear mechanism,
wherein the second functional unit is secured in a reversibly releasable manner on the first functional unit, in particular by means of a clamping mechanism,
wherein, in particular in order to carry out different measurements, the first and the second functional unit are separated from one another and a different first or second functional unit is in each case connected to the first or the second functional unit, and the viscosity of the sample is then determined.

Another aspect of the present invention consists in providing a rotary viscosimeter by means of which measurement of the viscosity can be carried out easily while reducing sources of error in determining the viscosity.

This object is achieved in the case of a rotary viscosimeter as per the preamble of patent claim 13 by means of the characterizing features. According to the invention, it is envisaged here that the rotary viscosimeter has an adjusting drive for adjusting the clearance between the measuring body and the second measuring part, wherein the adjusting drive is connected to the measuring body and/or the second measuring part by means of a gear mechanism in such a way that the measuring gap between the measuring body and the measuring cup can be set by means of the adjusting drive. By means of the adjusting drive, it is possible to easily set the measuring gap between the measuring body and the measuring cup or second measuring part and also easily to automatically repeat or reproduce previously implemented settings. This reduces the susceptibility to error, particularly in the case of frequent use or use by untrained personnel.

In order to be able to compensate for manufacturing tolerances of the individual parts of the rotary viscosimeter, in particular of the measuring body and the second measuring part, by means of calculation methods, provision can be made for the rotary viscosimeter to have an evaluation unit, wherein the evaluation unit is designed in such a way that the evaluation unit can be supplied with a correction table in which correction values for the respective pairing of the measuring body and the second measuring part are recorded and wherein, during the determination of viscosity by the evaluation unit, the correction table is taken into account and, in this way, a corrected value of the viscosity is determined.

Provision can advantageously be made for the rotary viscosimeter to have a spindle extraction mechanism, by means of which the measuring body can be automatically separated from the measuring shaft.

One preferred embodiment of the spindle extraction mechanism can be provided in which the spindle extraction mechanism has an electromagnet with current interruption, a permanent magnet, a removal mechanism, spring clips or quick-action closures, wherein the spindle extraction mechanism is designed in such a way that the measuring body can be automatically separated or decoupled from the measuring shaft. As already described above, the spindle extraction mechanism can be used to separate the measuring body automatically from the measuring shaft and, in this way, to avoid burns or incorrect handling in a particularly simple manner.

To enable the sample to be heated or cooled easily to a predetermined temperature level, provision can be made for the second measuring part to have a temperature control element, in particular a Peltier element, by means of which the temperature of the sample can be set, and wherein the second measuring part has an insulating element, by means of which the second measuring part is at least partially thermally insulated from the surroundings.

To avoid burns during the installation of the second measuring part, provision can optionally be made for the second measuring part to have a grip, which is thermally insulated with respect to the sample receiving region of the second measuring part.

A preferred embodiment envisages that the rotary viscosimeter consists of at least two functional units, wherein the first functional unit comprises the drive, the measuring shaft, the measuring unit and the stand of the rotary viscosimeter, and wherein the second functional unit comprises the second measuring part, the adjusting drive and the gear mechanism, wherein the second functional unit is secured in a reversibly releasable manner on the first functional unit, in particular by means of a clamping mechanism.

Further advantages and embodiments of the invention will become apparent from the description and the accompanying drawings.

In the following, the invention is illustrated schematically in the drawings by means of exemplary embodiments, which are particularly advantageous but should not be interpreted as restrictive, and is described by way of example with reference to the drawings:

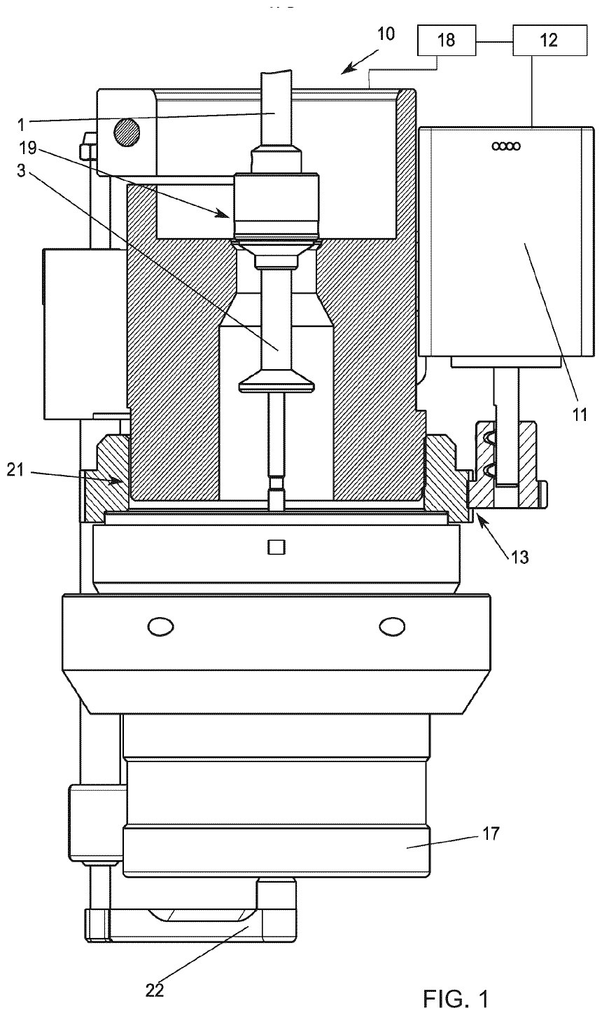

FIG. 1 shows a sectioned view of a rotary viscosimeter according to the invention in a schematic illustration,

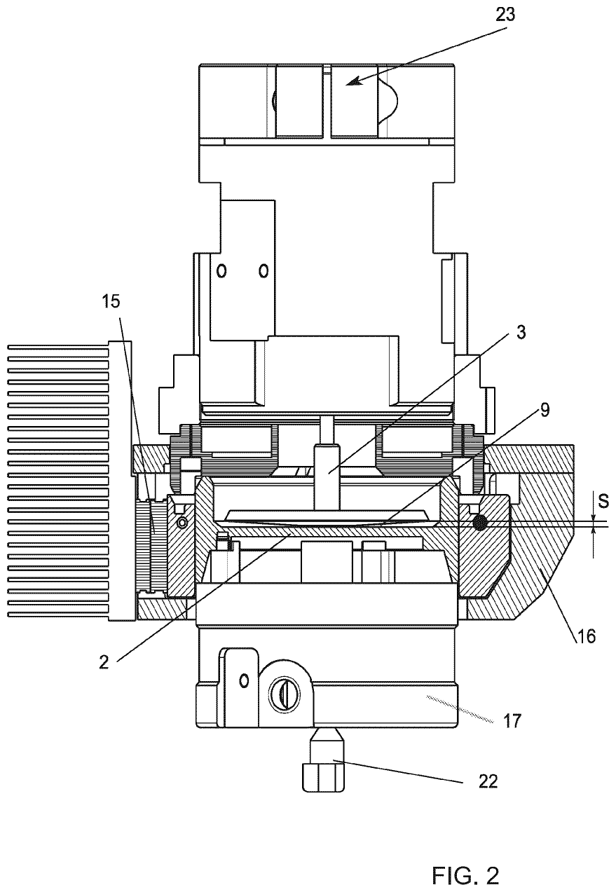

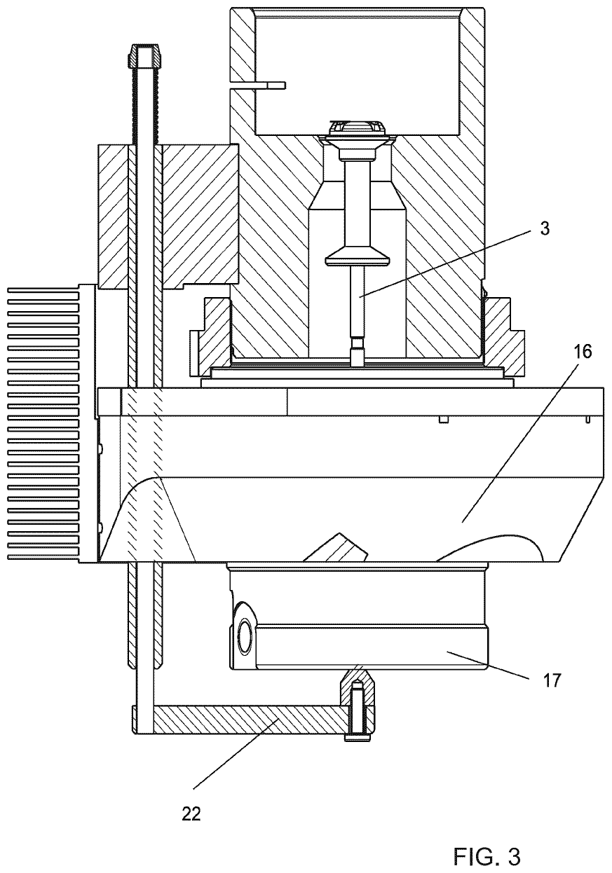

FIGS. 2 and 3 show further sectioned views of the rotary viscosimeter according to the invention shown in FIG. 1,

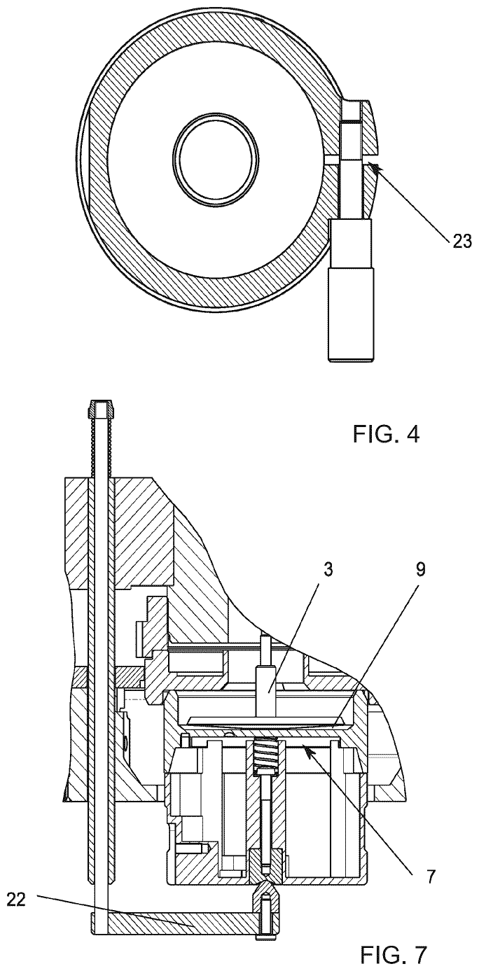

FIG. 4 shows a detail view of the clamping mechanism for the second functional unit in a sectioned view,

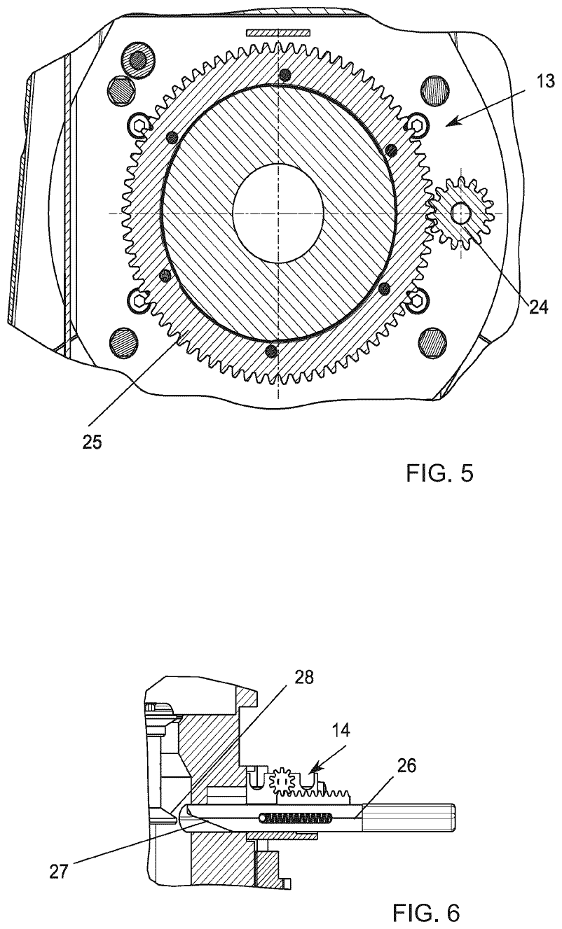

FIG. 5 shows a sectioned view of the adjusting drive with the associated gear mechanism,

FIG. 6 shows a detail view of an optional embodiment of the spindle extraction mechanism, and

FIG. 7 shows an embodiment with a bracket designed as a holder.

FIG. 1 illustrates a first preferred embodiment of the rotary viscosimeter 10 according to the invention in a schematic sectioned view. The rotary viscosimeter 10 comprises a measuring unit (not illustrated), a drive (not illustrated), which drives a measuring shaft 1. A measuring body, in this embodiment a spindle, is secured on the measuring shaft 1. In this instance, the measuring body 3 is secured on the end of the measuring shaft 1 by means of a coupling unit 19. A second measuring part 7, which is designed as a measuring cup (FIG. 2), is arranged in the lower part of the rotary viscosimeter 10, opposite the measuring body 3. The measuring body 3 is positioned opposite the second measuring part 7, and a measuring gap S is set between the measuring body 3 and the second measuring part 7 during the analysis of a sample 9. In this instance, the measuring gap S is set by means of an adjusting drive 11, which is connected to the height adjusting mechanism 21 by a gear mechanism 13. When the adjusting drive 11 is actuated by means of the control unit 12, the height adjusting mechanism 21 is actuated, and the measuring cup or the second measuring part 7 is adjusted along the axis of the measuring body 3 or the measuring shaft 1 by way of a thread. In this embodiment, the height adjusting mechanism 21 is connected to the second measuring part 7 by a thread and, when activated, is rotated relative to the second measuring part 7 by means of the adjusting drive 11 and, in this way, the clearance between the measuring body 3 and the second measuring part 7 is adjusted by way of the thread.

A method for ascertaining the viscosity of a sample 9 by means of a rotary viscosimeter 10 is described by way of example below with reference to a preferred embodiment of the method according to the invention.

In the method according to the invention, the measuring body 3 is arranged on the measuring shaft 1, and the second measuring part 7 is arranged on a rotary viscosimeter 10 or secured on the latter. In a second step, the clearance between the measuring body 3 and the second measuring part 7 is then reduced by means of the adjusting drive 11 until there is contact between the measuring body 3 and the second measuring part 7. Contact between the measuring body 3 and the second measuring part 7 is monitored by means of a current flow. Thus, to check the current flow, a continuous voltage of three volts is applied by the rotary viscosimeter 10 via a bracket 22 arranged at the lower end of the second measuring part 7 and, when there is contact between the measuring body 3 and the second measuring part 7, a current flow via the second measuring part 7, the measuring body 3 and the measuring shaft 1 is detected. If contact between the measuring body 3 and the second measuring part 7 is detected by way of the current flow, the adjusting drive 11 stops the reduction of the clearance, and a zero gap is defined or detected in the control unit 12 or evaluation unit 18. As an alternative, the zero gap can also be implemented via “loose point determination”, in which, upon detection of contact between the measuring body 3 and the second measuring part 7, the clearance between these two is increased again until the voltage or the current flow breaks off. When the current flow breaks off, this “loose point” is alternatively then defined as the zero gap between the measuring body 3 and the second measuring part 7.

In a third step, the clearance between the measuring body 3 and the second measuring part 7 is then increased from the zero gap and the measuring gap S required for the respective measurement of the viscosity of the sample 9 is set. In a fourth step, after the setting of the measuring gap S, the second measuring part 7 is removed, and the sample 9 is introduced into the second measuring part 7 or measuring cup or is placed thereon, and the second measuring part 7 is secured on the rotary viscosimeter 10 again, with the result that the measuring body 3 is wetted by the sample or dipped into the latter. In a fifth step, the viscosity measurement is then carried out on the sample 9, and the viscosity of the sample 9 is determined by means of the evaluation unit 18.

In one preferred embodiment of the method according to the invention, the evaluation unit 18 is supplied with correction values or a correction table containing correction values. The correction table or correction values take account of the pairing of the measuring body 3 with the second measuring part 7. The correction values are taken into account by the evaluation unit 18 in evaluating the viscosity of the sample 9 and, for example, may include manufacturing tolerances or dimensional deviations of the pairing of the measuring body 3 with the second measuring part 7. The correction table or correction values can be determined on the rotary viscosimeter 10 itself, for example, by measuring reference liquids with a known viscosity and storing or generating the differing viscosity with the respective measuring bodies 3 or second measuring part 7. Alternatively, the correction table or correction values may also be obtained directly in a reference viscosimeter, after the production of the respective measuring body 3 and of the second measuring part 7, also, for example, by measuring respective samples 9 of known viscosity and then determining the correction values. The correction values or correction table can optionally be stored in a memory of the rotary viscosimeter 10, or can be made available to the rotary viscosimeter 10 and/or the evaluation unit 18 via a wireless or wired connection, e.g. via W-LAN or a server download.

In generating the correction table or correction values, it is additionally possible to take into account the thermal expansion of the measuring body 3 and/or of the second measuring part 7, thus enabling the respective thermal expansion of the measuring body 3 and/or of the second measuring part 7 to be taken into account in evaluating the viscosity. It is also possible for the individual speeds of the measuring shaft 1 or of the measuring body 3 or of the second measuring part 7 that are required, for example, in test protocols to be taken into account in the generation of the correction table or correction values and, for example, for reference measurements to be carried out under the exact measuring conditions. To generate the correction values or correction table, it is possible, for example, likewise to take into account the reference measurement or measurement of the measuring bodies 3 or second measuring parts 7 by heating the parts or the sample to the respective measurement temperature.

As an option, the rotary viscosimeter 10 may also have a detection module which automatically detects the respective second measuring part 7 installed and/or the respective measuring body 3 installed. When the respective measuring body 3 and the second measuring part 7 are detected, the respective correction value for the viscosity value is then selected by the evaluation unit 18 and the correction value is taken into account in measuring the viscosity of the sample 9.

As an option, the respective measuring body 3 and/or the respective second measuring part 7 can, for example, comprise an NFC chip or a barcode, which is automatically read out by means of the detection module during the installation of the respective second measuring part 7 and/or of the respective measuring body 3, and in this way the evaluation unit 18 can be supplied with a corresponding correction value. As an option, it is also possible, for example, for the correction value to be transferred to the evaluation unit 18 or the detection module by means of NFC chips directly upon installation on the rotary viscosimeter 10, wherein the respective correction value can be stored or recorded on the NFC chip or the detection feature.

In one preferred embodiment of the rotary viscosimeter 10 according to the invention, which is illustrated in FIG. 6, this has a spindle extraction mechanism 14. With the aid of the spindle extraction mechanism 14, the spindle or measuring body 3 mounted on the measuring shaft 1 can be separated from the latter and, without the need to touch the spindle or measuring body 3, can be removed from the rotary viscosimeter 10. Thus, for example, with the second measuring part 7 installed, the spindle extraction mechanism 14 can be automatically actuated, the spindle removed from the measuring shaft 1 and caught or picked up by the second measuring part 7. These can then be removed jointly from the rotary viscosimeter 10. The spindle extraction mechanism 14 has a linear drive, which moves a removal pin 26 in the direction of the measuring body 3. In this instance, an oblique removal edge 27 of the removal pin 26 strikes an edge 28 of equal and opposite shape on the measuring body 3. When the two edges meet, the removal pin 26 exerts a force on the measuring body 3 and overcomes a magnetic force, for example, in the coupling unit 19 between the measuring shaft 1 and the measuring body 3. After the separation of the measuring body 3 from the measuring shaft 1, the measuring body 3 falls and is caught by the removal pin 26 or the upper edge thereof and is thus optionally prevented from falling out and possibly being damaged.

As illustrated in FIG. 6, it is possible, for example, for the spindle extraction mechanism 14 to be actuated by means of a linear drive and, in this way, for the measuring body 3 to be removed from the measuring shaft 1. Alternatively, the spindle extraction mechanism 14 can be formed by an electromagnet which is secured on the measuring shaft 1, interacts with a permanent magnet or electromagnet arranged on the measuring body 3 and, when the spindle extraction mechanism 14 is actuated, cancels or switches off the force holding the measuring body 3 on the measuring shaft 1, and in this way the measuring body 3 is separated from the measuring shaft 1. Alternatively, the spindle extraction mechanism 14 may also be formed by means of a removal mechanism, spring clips or other quick-acting closures known from the prior art.

As illustrated in FIGS. 1 to 3, it is possible in a preferred embodiment of the rotary viscosimeter 10 for the second measuring part 7 to have a heating element 15, in this embodiment Peltier elements. By means of the heating element 15, the temperature of the sample 9 during the viscosity analysis is set, and the temperature is increased by heating the measuring cup 7. As an option, Peltier elements or other temperature control elements 15 may also be used to lower the temperature of the sample 9 or to selectively cool the second measuring part 7, the measuring body 3 and the sample 9.

In one preferred embodiment of the rotary viscosimeter 10 according to the invention, the second measuring part 7 has an insulating element 16 (FIG. 2), by means of which the second measuring part 7 is thermally insulated from the surroundings of the rotary viscosimeter 10. By virtue of the thermal insulation, the temperature control elements 15 can work particularly effectively, and the temperature of the sample 9 can be set more accurately and with less expenditure of energy.

In one optional embodiment, the rotary viscosimeter 10 can consist of two or more functional units. The second functional unit comprises the second measuring part 7, the adjusting drive 11 and the gear mechanism 13, wherein the first functional unit comprises the drive, the measuring shaft 1, the measuring unit and the stand of the rotary viscosimeter 10. As illustrated in FIG. 4, the second functional unit can be secured on the first functional unit by means of a clamping mechanism 23. By actuation of the clamping mechanism 23, the second functional unit can then be mounted with the second measuring part 7 either on the first functional unit or the rotary viscosimeter 10 or removed from the latter. When the clamping mechanism 23 is actuated, the clamping mechanism is, as illustrated in FIG. 4 for example, opened and, in this way, the second functional unit, with the second measuring part 7 or second measuring part 7 designed as a measuring cup, is removed from the rotary viscosimeter 10 or first functional unit.

As illustrated in FIGS. 1 to 3 and 7, the second measuring part 7 can be secured on the housing of the rotary viscosimeter 10 by clamping using a bracket 22. If the bracket 22 is pivoted to the side, the second measuring part 7 can then be removed from the rotary viscosimeter 10 or exchanged. If the bracket is pivoted back again, the second measuring part 7 is then once again connected to the rotary viscosimeter 10 and held on the latter in a manner fixed against movement. Optionally, it is possible, in an embodiment that is not illustrated, for the second measuring part 7 to be secured on the rotary viscosimeter 10 by means of a clamping mechanism or screw mechanism.

As an option, as illustrated by way of example in FIGS. 1 to 3, the second measuring part 7 or measuring cup can have a grip 17, which is thermally insulated with respect to the sample receiving region of the measuring cup 7 in which the sample 9 is arranged. The grip 17 makes it possible to separate the measuring cup from the rotary viscosimeter 10 without causing burns to users, even at high temperatures of the sample 9 or heated sample 9. Alternatively, the measuring cup or second measuring part 7 can also be connected to the rotary viscosimeter 10 by means of other clamping elements.

FIG. 5 illustrates a preferred embodiment of the adjusting drive 11 according to the invention. At one end of the shaft, the adjusting drive 11 (FIG. 1) has a first gearwheel 24, which is connected to the height adjusting mechanism 21 of the rotary viscosimeter 10 by means of a second gearwheel 25. When the adjusting drive 11 is actuated, the first gearwheel 24 is rotated and, via the latter, the second gearwheel 25. When the second gearwheel 25 is rotated, the clearance is then changed by way of a thread or a spindle between the second measuring part 7 and the measuring body 3.

In one optional embodiment, it is also possible, after the third step (c) of the method according to the invention, for the setting of the measuring gap S to be stored and for the clearance between the measuring body 3 and the second measuring part 7 to be increased and, in the fourth step (d), for the second measuring part 7 to be removed, and then for a sample 9 to be introduced into the second measuring part 7. After the introduction of the sample 9 into the second measuring part 7, said part is then repositioned on the rotary viscosimeter 10, and the stored clearance between the measuring body 3 and the second measuring part 7 or the previously stored measuring gap S is then re-established. As the clearance between the measuring body 3 and the measuring cup 7 is reduced, the measuring body 3 is introduced into the measuring cup 7 and is wetted with the sample 9 located in the second measuring part 7 or dipped into said sample. Following this, as described above, determination of the viscosity can then be carried out by means of the evaluation unit 18.

1-19. (canceled)

20. A method for ascertaining a viscosity of a sample using a rotary viscosimeter having a measuring shaft driven by a drive, a measuring body which is disposed at one end of the measuring shaft and is subjected to the sample, and a second measuring part into which the sample is introduced, which comprises the steps of:
(a) attaching the measuring body on the measuring shaft and attaching the second measuring part on the rotary viscosimeter;
(b) reducing a clearance between the measuring body and the second measuring part until a previously defined current can flow between the measuring body and the second measuring part, thus defining a zero gap between the measuring body and the second measuring part, or the clearance between the second measuring part and the measuring body is increased again and a point at which the current flow is interrupted is defined as the zero gap between the measuring body and the second measuring part;
(c) increasing the clearance between the measuring body and the second measuring part from the zero gap and, in this way, a defined measuring gap is set, wherein in order to adjust the clearance between the measuring body and the second measuring part, an adjusting drive is provided, wherein the defined measuring gap is specified by a controller using the adjusting drive;
(d) removing the second measuring part, introducing the sample into the second measuring part, and repositioning the second measuring part; and
(e) carrying out a viscosity measurement on the sample, and the viscosity of the sample is determined by means of an evaluation unit.

21. The method according to claim 20, wherein said evaluation unit is supplied with a correction table in which correction values for a respective pairing of the measuring body and the second measuring part are recorded and wherein, during a determination of the viscosity by the evaluation unit, the correction table is taken into account and, in this way, a corrected value of the viscosity is determined.

22. The method according to claim 21, wherein the correction table and/or the correction values for different temperatures and/or speeds, which each correspond to the speeds and temperatures of test conditions, are supplied to the evaluation unit.

23. The method according to claim 21, wherein the correction table is generated by means of analyses carried out on the rotary viscosimeter or a reference viscosimeter, or the correction table is generated by means of analyses after a production of the measuring body and/or the second measuring part and is made available to the rotary viscosimeter, wherein respective samples of known viscosity are used for a generation of the correction table and/or of the correction values.

24. The method according to claim 21, wherein:
the rotary viscosimeter has a detection module, which automatically detects the second measuring part installed and/or the measuring body installed, wherein the evaluation unit selects the correction value for the viscosity value from the correction table with reference to the detected measuring body and the second measuring part; and
the correction table or the correction value is stored in the measuring body and/or the second measuring part, and the correction table or the correction value is transferred to the evaluation unit by the detection module when the measuring body and/or the second measuring part is installed on the rotary viscosimeter.

25. The method according to claim 20, wherein, on completion of measurement, the measuring body is automatically or selectively ejected by means of a spindle extraction mechanism.

26. The method according to claim 20, wherein:
at least one of the rotary viscosimeter or the second measuring part has a temperature control element, by means of which a temperature of the sample is set before a start of measurement; and
at least one of the second measuring part or the rotary viscosimeter has an insulating element, by means of which the second measuring part is at least partially thermally insulated from surroundings.

27. The method according to claim 21, wherein the correction values for a thermal expansion of the measuring body and/or of the second measuring part are additionally recorded in the correction table, wherein the thermal expansion of at least one of the measuring body or of the second measuring part is taken into account in setting the defined measuring gap and/or in evaluating the viscosity.

28. The method according to claim 20, wherein on completion of measurement, at least one of the measuring body or the second measuring part is exchanged, and determination of the viscosity of a new or of a same said sample is carried out with a same said rotary viscosimeter and a different measuring body and/or a different second measuring part.

29. The method according to claim 21, wherein:
at least one of the measuring body or the second measuring part has a detection feature which, when the measuring body and/or the second measuring part is inserted, is detected or read out by the rotary viscosimeter and/or the evaluation unit; and
at least one of the correction value or the correction table is supplied to the evaluation unit for evaluation of the viscosity and/or is selected by the evaluation unit.

30. The method according to claim 20, wherein:
in the step (c), a setting of the defined measuring gap is stored and the clearance between the measuring body and the second measuring part is increased; and
in the step (d), the second measuring part is removed and the sample is introduced into the second measuring part, the second measuring part is repositioned and the clearance between the measuring body and the second measuring part is reduced, wherein the measuring body is dipped into the second measuring part with the sample located therein, and a previously stored measuring gap is set again.

31. The method according to claim 20, wherein the rotary viscosimeter contains at least two functional units including a first functional unit having the drive, the measuring shaft, a measuring unit and a stand of the rotary viscosimeter, and a second functional unit having the second measuring part, the adjusting drive and a gear mechanism, the second functional unit is secured in a reversibly releasable manner on the first functional unit; and
in order to carry out different measurements, the first and the second functional units are separated from one another and a different first or second functional unit is in each case connected to the first or the second functional unit, and the viscosity of the sample is then determined.

32. The method according to claim 20, wherein the measuring body is a spindle, a conical measuring body or a plate.

33. A rotary viscosimeter for measuring a viscosity of a sample, the rotary viscosimeter comprising:
a drive;
a measuring shaft driven by said drive;
a measuring body disposed at one end of said measuring shaft and being subjected to the sample;
a second measuring part, into which the sample is introduced;
a gear mechanism; and
an adjusting drive for adjusting a clearance between said measuring body and said second measuring part, said adjusting drive is connected to said measuring body and/or said second measuring part by means of said gear mechanism such that a measuring gap between said measuring body and said measuring part being set by means of said adjusting drive.

34. The rotary viscosimeter according to claim 33, further comprising an evaluation unit configured such that said evaluation unit is supplied with a correction table in which correction values for a respective pairing of said measuring body and said second measuring part are recorded and wherein, during a determination of the viscosity by said evaluation unit, the correction table is taken into account and, in this way, a corrected value of the viscosity is determined.

35. The rotary viscosimeter according to claim 33, further comprising a spindle extraction mechanism, by means of which said measuring body is automatically separated from said measuring shaft.

36. The rotary viscosimeter according to claim 35, wherein:
said spindle extraction mechanism has an electromagnet with current interruption, a permanent magnet, a removal mechanism, and spring clips or quick-action closures; and
said spindle extraction mechanism is configured such that said measuring body is automatically separated or decoupled from said measuring shaft.

37. The rotary viscosimeter according to claim 33, wherein:
said second measuring part has a temperature control element by means of which a temperature of the sample is set; and
said second measuring part has an insulating element, by means of said insulating element said second measuring part is at least partially thermally insulated from surroundings.

38. The rotary viscosimeter according to claim 33, wherein said second measuring part has a grip, said grip is thermally insulated with respect to a sample receiving region of said second measuring part.

39. The rotary viscosimeter according to claim 33, further comprising at least two functional units including:
a first functional unit having said drive, said measuring shaft, a measuring unit and a stand of the rotary viscosimeter;
a second functional unit having said second measuring part, said adjusting drive and a gear mechanism; and
said second functional unit is secured in a reversibly releasable manner on said first functional unit.
